(19) United States
(12) Patent Application Publication
(10) Pub. No.: US 2004/0161099 A1
(43) Pub. Date: Aug. 19, 2004

(54) Key signal scanning apparatus of complex telephone

(76) Inventor: Hae-Jeung Lee, Daegu (KR)

Correspondence Address: Robert E. Bushnell, Suite 300, 1522 K Street, N.W., Washington, DC, 20005-1202, US

(21) Appl. No.: 10/757,492

(22) Filed: Jan. 15, 2004

(30) Foreign Application Priority Data
Jan. 24, 2003 (KR) 10-2003-4961

(51) Int. Cl. H04M 1/00; H04M 3/00

(52) U.S. Cl. 379/368; 379/387.01

(57) ABSTRACT

A key signal scanning apparatus of a complex telephone comprises: a keypad having plural row ports, plural column ports, and plural keys for generating a key signal in accordance with pressing of a key by a user; a main microprocessor which operates by externally supplied power for supplying a timing signal to the row ports of the keypad by using row output ports, for receiving the key signal from the column ports of the keypad by using column input ports, for detecting a key pressed by the user by scanning the received key signal, and for outputting a dialing signal corresponding to the scanned key; a sub microprocessor which operates when power is not supplied from an external source for outputting a dialing signal generated according to the key signal inputted from the row ports and the column ports of the keypad; a first separator circuit for cutting off current flow to the row output ports of the main microprocessor from the row ports of the sub microprocessor; and a second separator circuit for cutting off current flow to the column ports of the sub microprocessor from the column input ports of the main microprocessor when power is not supplied from the external source. The present invention can scan the key signal without reciprocal influence when external power is supplied and not supplied by provision of a separator circuit between the main microprocessor scanning the key signal when external power is supplied and the sub microprocessor scanning the key signal when external power is not supplied.

### CLAIM OF PRIORITY

This application makes reference to, incorporates the same herein, and claims all benefits accruing under 35 U.S.C. § 119 from my application KEY SCANNING APPARATUS IN COMPLEX TELEPHONE filed with the Korean Industrial Property Office on 24 Jan. 2003 and there duly assigned Serial No. 10-2003-4961.

### BACKGROUND OF THE INVENTION

1. Technical Field

The present invention relates to a key signal scanning apparatus of a complex telephone, and more particularly, to a key signal scanning apparatus of a complex telephone for scanning a key signal without a reciprocal influence when external power is supplied and not supplied. A separator circuit is installed between a main microprocessor which scans the key signal when external power is supplied and a sub microprocessor which scans the key signal when external power is not supplied.

2. Related Art

The main internal device of a telephone is composed of a bell device, a hook switch, and a dial. The dial of the telephone generates a signal transmitted to select a called party for an exchange, and is classified into a rotary dial (DP: Dial Pulse) and a push button dial (PB: Push Button or MFC: Multi Frequency Combination) for generating an audio frequency.

A spring of the rotary dial is wound up by turning a disc of the dial front in a clockwise direction and is unwound by turning the disc loose, thereby generating a dial impulse. There is a certain restriction on impulse period, make ratio, and minimum pause for such impulse row, and these three elements are called the ‘three elements of the dial’.

The three elements should be rigidly restricted on A-type and H-type automatic telephone switching equipment, but not in the case of cross bar-type and EMD-type switching equipment, since the impulse is outputted at a determined speed after being accumulated in a register circuit. Thus, it is possible to obtain high accuracy and sufficient margins, as well as higher speed.

Since an electronic exchange has a very quick switching speed, the dialing operation of a subscriber should be quicker with accuracy. However, a prior rotary dialing system cannot satisfy the above requirements. Thus, the push button dialing system, also known as a “touch tone dialing” system, has been developed.

The touch tone dialing system transmits an AC pulse to computers of the same and other stations by means of a frequency tone keying signal. The tone frequency oscillated by the touch tone dialing system is within the voice frequency range, and can be transmitted all over the world including Korea.

Eight frequencies, selected within a range of 700˜1,700 HZ, contain planned 4×4 codes for the push button dialing. These eight frequencies are selected so as not to receive high frequency crosstalk in connection with a call signal, and they are divided into four low frequencies and four high frequencies.

When a push button is pressed, two tones are generated, one from the high frequencies and one from the low frequencies. For instance, when a number “8” push button is pressed, an 852 Hz tone and a 1336 Hz tone are oscillated and transmitted.

Since ten push buttons correspond to ten number balls of the rotary dial and only a ten-frequency combination is required, it is possible to implement with a 4×3 code, except for 1633 Hz. Thus, the push buttons are disposed in a 4×3 array. Ten of twelve buttons correspond to the numbers 0-9, and two codes, such as * and #, are used for a specific function.

Recently, as telephones have rapidly incorporated ICs due to the development of semiconductor technology, electronic telephones using such technology have become popular. The biggest changes in these electronic telephones have been in telephone transmitter/receiver and dial parts. In addition, generation of a ringing tone by a magnet has been changed to generation by a tone ringer system, thereby remarkably reducing the number of mechanical parts in the telephones.

Particularly, special apparatus parts for the telephones have been substituted for existing parts due to the development of semiconductor technology, and the amplifying process is more easily performed by using transistors or ICs, thereby simplifying telephone transmitter/receiver design.

With respect to the dial, instead of using a mechanically complicated rotary dial, a modem dial is used and it electronically generates an interrupt signal (dial impulse) created in the rotary dial by an IC and a crystal oscillator or a ceramic oscillator, or it generates a DTMF signal created by the push buttons.

The generation of a ringing tone by a magnet has also been replaced by generation by a tone ringer system. The tone ringer system converts a 16 Hz call signal transmitted from a telephone office into a direct current, and uses the direct current as power. Then, it creates signals before and after 1 kHz, and generates a specific ringing tone through a ceramic sounding body (piezoelectric sounder). Accordingly, the number of mechanical parts has been remarkably reduced, enabling flexible design and generating various ringing tones.

As telephone circuits also tilize ICs, prior balanced circuits implemented by induction coils and condensers have been replaced by one LSI. In addition, since microprocessors and high capacity memory elements have been developed and LCDs (Liquid Crystal Displays) and LEDs (Light Emitting Diodes) have been cheaply supplied, a number display function of a clock or dial, as well as other similar functions, can be included in the telephone.

In the meantime, a telephone using a microprocessor supplies various special functions, such as a memory function for frequently-used telephone numbers and a short dial function for the memorized telephone numbers. To perform the above functions consistently, it is essential to always supply stable and regular power to the microprocessor built into the telephone.

Thus, a complex telephone operated under the control of a microprocessor is operated by receiving external power for the operation of the various circuits. For example, a microprocessor operates various circuits by inputting DC power of a predetermined level outputted from a DC adapter.

When the complex telephone operates each circuit by power supplied from an external power supplying device, it can maintain the basic telephone function of the telephone by using a loop voltage, such as −48V, supplied from a telephone line, even when operating power is not supplied due to power failure or other reasons.

Such function is commonly called an NPO (No Power Operation). In order to implement the basic telephone function in the NPO mode, another telephone IC is used. For example, partial functions are implemented by a speech network IC, a ringer IC, and a dialer IC, or all of these functions are performed by a single IC.

In a complex telephone which includes the NPO mode described above, a 3*4 keypad for a dial should be used in the following two cases: operating under control of the microprocessor when power is supplied from an external source; and operating in the NPO mode.

Since key scanning methods in the above two cases are differently implemented, a contact of the keypad is dualized. In this case, there is a problem of interference with the key scanning operation because the output ports and the input ports of each microprocessor are influenced by each other.

That is, residual currents remain in, or high impedance is set in, the output ports of each microprocessor. Thus, other microprocessor scans input a high level signal as if a key is pressed (although the key is not actually pressed), causing an erroneous operation. Alternatively, the residual currents or the high impedance in the output ports of each microprocessor can change an output value of an output port of another microprocessor, causing an erroneous operation.

The following patents are considered to be generally pertinent to the present invention, but are burdened by the disadvantages set forth above: U.S. Pat. No. 6,563,434 to Olodort et al., entitled SYSTEM AND METHOD FOR DETECTING KEY ACTUATION IN A KEYBOARD, issued on May 13, 2003; U.S. Pat. No. 5,266,950 to Gulick et al., entitled PROGRAMMABLE KEYPAD MONITOR, issued on Nov. 30, 1993; U.S. Pat. No. 5,235,635 to Gulick, entitled KEYPAD MONITOR WITH KEYPAD ACTIVITY-BASED ACTIVATION, issued on Aug. 10, 1993; U.S. Pat. No. 5,220,601 to Gulick et al., entitled KEYPAD STATUS REPORTING SYSTEM, issued on Jun. 15, 1993; U.S. Pat. No. 5,199,064 to Gulick et al, entitled FULLY-INTEGRATED TELEPHONE UNIT, issued on Mar. 30, 1993; U.S. Pat. No. 4,486,624 to Puhl et al., entitled MICROPROCESSOR CONTROLLED RADIOTELEPHONE TRANSCEIVER, issued on Dec. 4, 1984; U.S. Pat. No. 4,998,275 to Braunstein et al., entitled MULTI-LINE TELEPHONE COMMUNICATIONS SYSTEM, issued on Mar. 5, 1991; U.S. Pat. No. 4,954,823 to Binstead, entitled TOUCH KEYBOARD SYSTEMS, issued on Sep. 4, 1990; U.S. Pat. No. 4,860,339 to D'Agosto III et al., entitled PROGRAMMABLE TELEPHONE/DICTATION TERMINAL AND METHOD OF OPERATING SAME, issued on Aug. 22, 1989; U.S. Pat. No. 4,675,653 to Priestley, entitled KEY BOARD ARRANGEMENTS, issued on Jun. 23, 1987; U.S. Pat. No. 4,488,006 to Essig et al., entitled APPARATUS FOR CONTROLLING THE APPLICATION OF TELEPHONE LINE POWER INA TELEPHONE SET, issued on Dec. 11, 1984; U.S. Pat. No. 4,467,140 to Fathauer et al., entitled MICROPROCESSOR-BASED CORDLESS TELEPHONE SYSTEM, issued on Aug. 21, 1984; and U.S. Pat. No. 4,149,041 to Card et al., entitled TELEPHONE APPARATUS, issued on Apr. 10, 1979.

### SUMMARY OF THE INVENTION

It is, therefore, an object of the present invention to provide a key signal scanning apparatus of a complex telephone for scanning a key signal without reciprocal influence when external power is supplied and not supplied. A separator circuit is installed between a main microprocessor scanning the key signal when external power is supplied and a sub microprocessor scanning the key signal in an NPO mode when external power is not supplied.

To achieve the above object, there is provided a key signal scanning apparatus of a complex telephone, the apparatus comprising: a keypad having plural row ports, plural column ports, and plural keys for outputting a key signal by generating the key signal according to pressing of a key by a user; a main microprocessor operating by power supplied from an external source for supplying a timing signal to the column ports of the keypad by using row output ports, for receiving the key signal from the column ports of the keypad by using column input ports, for detecting a key pressed by the user by scanning the received signal, and for outputting a dialing signal corresponding to the scanned key; a sub microprocessor which operates when power is not supplied from an external source for outputting a dialing signal by generating the dialing signal according to the key signal inputted from the row ports and the column ports of the keypad; a first separator circuit for cutting off current flow to the row output ports of the main microprocessor from the row ports of the sub microprocessor; and a second separator circuit for cutting off current flow to the column ports of the sub microprocessor from the column input ports of the main microprocessor when power is not supplied from the external source.

In addition, it is desirable for the present invention to further include a third separator circuit for cutting off current flow to the column ports of the sub microprocessor from the column ports of the keypad when power is supplied from the external source.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a diagram of a configuration of a key signal scanning apparatus of a complex telephone in accordance with one embodiment of the present invention.

FIG. 2 is a timing diagram for signals outputted from column output ports of a main microprocessor of FIG. 1.

FIG. 3 is a diagram of a configuration of a key signal scanning apparatus of a complex telephone in accordance with another embodiment of the present invention.

### DETAILED DESCRIPTION OF THE PREFERRED EMBODIMENT

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. It will also be understood that, when a layer is referred to as being “on” another layer or substrate, it can be directly on the other layer or substrate or intermediate layers may be also be present. Moreover, each embodiment described and illustrated herein includes its complementary conductivity type embodiment as well.

Hereinafter, a key signal scanning apparatus of a complex telephone in accordance with desirable embodiments of the present invention will be more fully described with reference to the accompanying drawings.

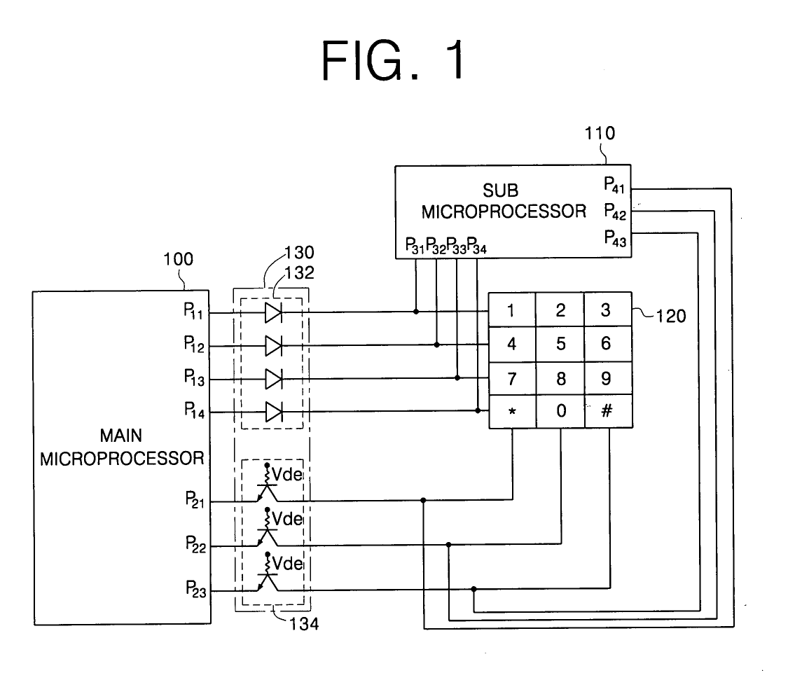

FIG. 1 is a diagram of a configuration of a key signal scanning apparatus of a complex telephone in accordance with one embodiment of the present invention.

As illustrated in FIG. 1, the key signal scanning apparatus of the complex telephone in accordance with one embodiment of the present invention comprises: a main microprocessor 100 which operates when power is supplied from an external source; a sub microprocessor 110 which operates by using a loop voltage when the power is not supplied from the external source; a keypad 120 disposed in a 4×3 array, wherein ten of twelve keys correspond to the numbers 0-9, and two keys (* and #) are used for specific functions; and a separator circuit 130 separating the main microprocessor 100 and the sub microprocessor 110.

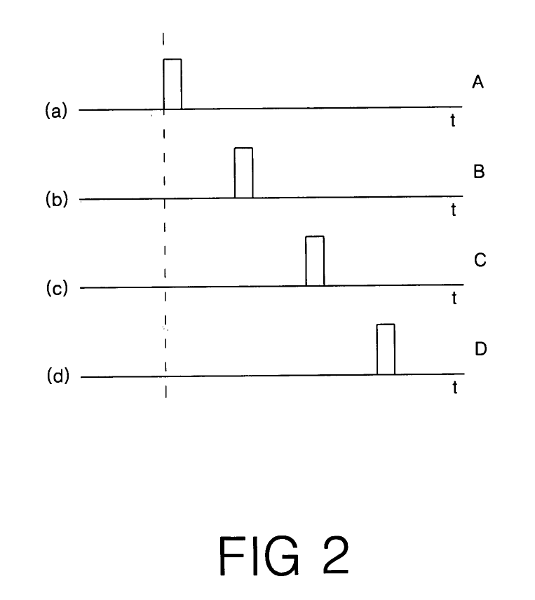

The main microprocessor 100 outputs a timing signal, as seen in FIG. 2, with a predetermined time difference in row output ports P11, P12, P13, P14.

As shown in FIG. 2, the outputted timing signal provides a high level signal at short time intervals in the highest row output port P11, and maintains a low level signal in other row output ports P12, P13, P14. After a certain time, it outputs a high level signal at short time intervals in the second row output port P12, and maintains a low level signal in the other row output ports P11, P13, P14.

In addition, after a certain time, it outputs a high level signal at short time intervals in the third row output port P13, and maintains a low level signal in the other row output ports P11, P12, P14.

Then, after a certain time, it outputs a high level signal at short time intervals in the fourth row output port P14, and maintains a low level signal in the other row output ports P11, P12, P13. Then, the timing signal is repeatedly outputted from the highest row output port P11.

The main microprocessor 100 decides which key signal is inputted by scanning column input ports P21, P22, P23, and scans the key signal.

For example, if a user presses the “5” key, a high level signal is detected in the second column input port P22 when the second row output port P12 of the main microprocessor 100 outputs the high level signal.

Also, if the user presses the “9” key, the high level signal is detected in the third column input port P23 when the third row output port P13 of the main microprocessor 100 outputs the high level signal.

Therefore, when the high level signal is detected in the column input ports P21, P22, P23, the main microprocessor 100 decides which one of the column input ports P21, P22, P23 outputs the signal and decides that a numeric key or a specific character key located in a corresponding column has been pressed. Next, to identify the row of the key which is pressed, the main microprocessor 100 identifies the pressed row by determining which one of the row output ports is pressed when the high level signal is detected, and scans the key signal. A process of identifying the row is described in detail as follows.

First, when the high level signal is detected in the column input ports P21, P22, P23, the main microprocessor 100 identifies the column from which the signal is detected, and determines when the key is pressed from the start time of the output of the high level signal of the highest row output port P11.

Then, when recognizing the time when the key is pressed from the start time of the outputting of the high level signal of the highest row output port P11, the main microprocessor 100 identifies the row output ports P11, P12, P13, P14 outputting the high level signal at the corresponding time, and recognizes that the key signal is inputted in a row of the corresponding row output ports P11, P12, P13, P14.

Meanwhile, the sub microprocessor 110 is driven by using a loop voltage, such as approximately −40V, when power is not supplied from an external source.

Such a loop voltage causes a ringing tone, converts a voice transmitted through a telephone receiver into a wavelength, and transmits the voice signal through the telephone line.

The sub microprocessor 110 generates and outputs a DTMF signal when keys of the keypad are pressed, by installing a DTMF (Dual Tone Multi Frequency) signal generator (not shown).

The DTMF signal is generated when a button of the general telephone is pressed, and is transmitted to a telephone office. The DTMF signal generator generates two tones having specific frequencies that corresponding to each key of the telephone pressed by a user. At this point, the DTMF signal is generated using one tone of a high frequency and another tone of a low frequency, in order not to imitate the tones with a voice only.

For example, the low frequency of the DTMF signal corresponding to a “1” key is 697 Hz, and the high frequency is 1209 Hz. The DTMF signal corresponding to a “2” key is 697 Hz and the high frequency is 1336 Hz.

A low frequency group of the DTMF signal for keys horizontally located in the keypad 120 is 697, 770, 852, and 941 Hz in order, and a high frequency group of vertical keys is 1209, 1336, and 1477 Hz in order.

When a key on the keypad 120 is pressed, the sub microprocessor 110 generates a “low group” frequency and “high group” frequency by using the DTMF signal generator. The frequencies are then synthesized and amplified with the use of an amplifier (not shown), and the amplified frequency signals are outputted.

The synthesized and amplified signals are transmitted to the telephone office via a voice circuit (not shown) and a hook switch (not shown). The telephone office identifies the number keys by separating and encoding the synthesized signals, and enables a call to be placed by connecting with the telephone line of a corresponding subscriber.

The separator circuit 130 electrically separates the main microprocessor 100 and the sub microprocessor 110, and comprises an output port separator circuit 132 and an input port separator circuit 134.

The output port separator circuit 132 passes output voltages from the row output ports P11, P12, P13, P14 of the main microprocessor 100, but cuts off current flow to the row output ports P11, P12, P13, P14 of the main microprocessor 100 from the row ports P31, P32, P33, P34 of the sub microprocessor 110.

Of course, the output port separator circuit 132 connected to the row output ports P11, P12, P13, P14 of the main microprocessor 100 permits the timing signal from the row output ports P11, P12, P13, P14 of the main microprocessor 100 to be inputted from the row ports P31, P32, P33, P34 of the sub microprocessor 110. However, it is experimentally proved that this has no big influence on the circuit 132.

Forward-connected diodes can be used in the output port separator circuit 132 connected to the row output ports P11, P12, P13, P14 of the main microprocessor 100, and such diodes provide excellent separation properties. Of course, it is possible to configure the separator circuit 132 by using transistors. At present, various elements for separator circuits are available.

The input port separator circuit 134 is connected to the front end of the column input ports P21, P22, P23 of the main microprocessor 100, thereby cutting off leakage current generated in the column input ports P21, P22, P23 of the main microprocessor 100 so that the leakage current is not inputted to column ports P41, P42, P43 of the sub microprocessor 110.

Bipolar transistors can be used in the input port separator circuit 134 connected to the column input ports P21, P22, P23 in the main microprocessor 100, and such bipolar transistors provide excellent separation properties. A collector terminal of each bipolar transistor is connected to a column port of the keypad 120, and an emitter terminal thereof is connected to a column input port of the main microprocessor 100.

Of course, it is possible to configure the separator circuit 134 by using field effect transistors. At present, various elements for separator circuits are available.

When the main microprocessor 100 is operated by receiving power from an external source, the input port separator circuit 134 is turned on as a reference voltage Vde is applied to a base terminal of the bipolar transistors, and the main microprocessor 100 scans the key signal as a column output current of the keypad 120 is applied to the column input ports P21, P22, P23 of the main microprocessor 100.

If the main microprocessor 100 is not operating because power supply is cut off from the external source, the bipolar transistor of the input port separator circuit 134 is turned off. Thus, the column output current of the keypad 120 is not applied to the main microprocessor 100, and impedance or leakage current of the column input ports P21, P22, P23 of the main microprocessor 110 is not applied to the column ports P41, P42, P43 of the sub microprocessor 110.

In the meantime, as shown in FIG. 1, since the bipolar transistor of the input port separator circuit 134 has impedance but the column ports P41, P42, P43 of the sub microprocessor 110 do not have impedance, an output signal of the keypad 120 may be inputted to the sub microprocessor 110, rather than to the main microprocessor 100.

Thus, more output signals of the keypad 120 should be inputted to the main microprocessor 100 when power is supplied from the external source.

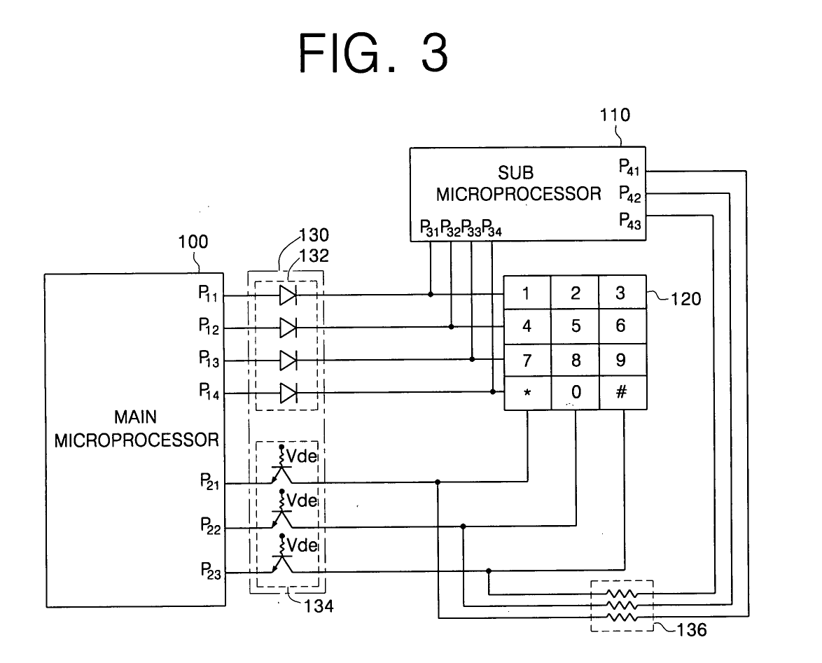

FIG. 3 is a diagram of a configuration of a key signal scanning apparatus of a complex telephone in accordance with another embodiment of the present invention.

In contrast to the diagram of FIG. 1, in the arrangement of FIG. 3, a resistance 136 is provided at the front end of column ports P41, P42, P43 of sub microprocessor 110.

The resistance 136 provided at the front end of the column ports P41, P42, P43 of the sub microprocessor 110 prevents a column signal of the keypad 120, inputted to the main microprocessor 100, from being inputted to the sub microprocessor 110 when power is supplied from an external source.

According to the present invention, as described above, it is possible to scan the key signal without reciprocal influence between the main microprocessor 100 scanning the key signal when external power is supplied and the sub microprocessor 100 scanning the key signal when external power is not supplied.

It is to be understood that changes and modifications to the embodiments described above will be apparent to those skilled in the art, and are contemplated. It is therefore intended that the foregoing detailed description be regarded as illustrative rather than limiting, and that it be understood that it is the following claims, including all equivalents, that are intended to define the spirit and scope of this invention.

What is claimed is:

1. A key signal scanning apparatus of a complex telephone operated by using external power and by using a loop voltage when the external power is not supplied, said apparatus comprising:
a keypad having row ports, column ports, and keys for outputting a key signal in accordance with pressing of a key by a user;
a main microprocessor which operates by the external power for supplying a timing signal to the row ports of the keypad by using row output ports, for receiving the key signal from the column ports of the keypad by using column input ports, for detecting the key pressed by the user by scanning the received key signal, and for outputting a first dialing signal corresponding to the detected key;
a sub microprocessor which operates when the external power is not supplied for outputting a second dialing signal according to the key signal from the keypad, the sub microprocessor having row ports and column ports;
a first separator circuit for cutting off current flow to the row output ports of the main microprocessor from the row ports of the sub microprocessor; and
a second separator circuit for cutting off current flow to the column ports of the sub microprocessor from the column input ports of the main microprocessor when the external power is not supplied.

2. The key signal scanning apparatus of claim 1, further comprising a third separator circuit for cutting off current flow to the column ports of the sub microprocessor from the column ports of the keypad when the external power is supplied.

3. The key signal scanning apparatus of claim 2, wherein the third separator circuit comprises resistance elements connected to each column port of the keypad and to each column port of the sub microprocessor.

4. The key signal scanning circuit of claim 2, wherein the second separator circuit has an output connected to the column inputs of the main microprocessor, and an input connected to both the column ports of the keypad and a first side of the third separator circuit, a second side of the third separator circuit being connected to the column ports of the sub microprocessor.

5. The key signal scanning circuit of claim 1, wherein the first separator circuit comprises diode elements having anode terminals connected to respective row output ports of the main microprocessor, and having cathode terminals connected to respective row ports of the keypad.

6. The key signal scanning apparatus of claim 1, wherein the second separator circuit comprises bipolar transistor elements having emitter terminals connected to respective column input ports of the main microprocessor, and having collector terminals connected to respective column ports of the keypad.

7. The key signal scanning apparatus of claim 1, wherein the second separator circuit comprises field effect transistor elements having source terminals connected to respective column input ports of the main microprocessor, and having drain terminals connected to respective column ports of the keypad.

8. The key signal scanning apparatus of claim 1, wherein the first separator circuit has an input connected to the row output ports of the main microprocessor, and an output connected to both the row ports of the sub microprocessor and the row ports of the keypad.

9. A key signal scanning apparatus of a complex telephone operated by using external power and by using a loop voltage when the external power is not supplied, said apparatus comprising:
a keypad having row ports, column ports, and keys for outputting a key signal in accordance with pressing of a key by a user;
a main microprocessor which operates by the external power for supplying a timing signal to the row ports of the keypad by using row output ports, for receiving the key signal from the column ports of the keypad by using column input ports, for detecting the key pressed by the user by scanning the received key signal, and for outputting a first dialing signal corresponding to the scanned key;
a sub microprocessor which operates when the external power is not supplied for outputting a second dialing signal according to the key signal from the keypad, the sub microprocessor having row ports and column ports;
a first separator circuit for cutting off current flow to the column ports of the sub microprocessor from the column input ports of the main microprocessor when the external power is not supplied; and
a second separator circuit for cutting off current flow to the column ports of the sub microprocessor from the column ports of the keypad when the external power is supplied.

10. The key signal scanning apparatus of claim 9, wherein the second separator circuit comprises resistance elements connected to each column port of the keypad and to each column port of the sub microprocessor.

11. The key signal scanning apparatus of claim 9, wherein the first separator circuit has an output connected to the column inputs of the main microprocessor, and an input connected to both the column ports of the keypad and a first side of the second separator circuit, a second side of the second separator circuit being connected to the column ports of the sub microprocessor.

12. The key signal scanning apparatus of claim 9, wherein the first separator circuit comprises bipolar transistor elements having emitter terminals connected to respective column input ports of the main microprocessor, and having collector terminals connected to respective column ports of the keypad.

13. The key signal scanning apparatus of claim 9, wherein the first separator circuit comprises field effect transistor elements having source terminals connected to respective column input ports of the main microprocessor, and having drain terminals connected to respective column ports of the keypad.
